(19) United States
(12) Patent Application Publication
(10) Pub. No.: US 2011/0146477 A1
(43) Pub. Date: Jun. 23, 2011

(54) String instrument educational device

(76) Inventor: Ryan Hiroaki Tsukamoto, Honolulu, HI (US)

(21) Appl. No.: 12/928,891

(22) Filed: Dec. 21, 2010

Related U.S. Application Data
(60) Provisional application No. 61/284,726, filed on Dec. 21, 2009.

(51) Int. Cl. G09B 15/06

(52) U.S. Cl. 84/485 R

(57) ABSTRACT

A string instrument educational device implemented on a computer having a touch screen (100) that causes a note representation of a musical note (140) to appear and travel along a string representation (having locations to depress to cause the string representation to play a corresponding plurality of notes) to a target area (150) a time interval before the note is to be played. The note representation (140) preferably reacts when the musical note has been correctly played by the user touching the touch screen (100) at the correct location when the note representation reaches the target area (150). The note representation preferably reflects which location must be touched to correctly play the note.

### TECHNICAL FIELD

This invention relates to a computer program installed on an electronic device with a touch screen and a speaker capable of sensing multiple touches (herein referred to as “device”), optionally also including a microphone, which teaches the user to play any song on any string instrument. The method of instruction avoids conventional musical notation—a notorious barrier to learning music on any instrument—in favor of a more intuitive representation. The computer program also offers a mode of instruction on a playable visual representation of any string instrument. This avoids the costs and delays associated with shopping for and purchasing a beginner's string instrument (not to mention the strain on one's ears that such an instrument produces), as well as shopping for and purchasing each subsequent instrument (be it a higher-quality instrument or simply a bigger instrument for a growing child), until such an instrument is preferable to the virtual instrument provided on the device.

The translation of sheet music to such a more intuitive representation (a digitization of sheet music), avoids the need to learn conventional music notation and the costs of purchasing sheet music, especially in the case of music used for teaching music theory—scales in music theory, chord scales, broken chord scales, and chord progressions, can be automatically generated and made freely available for every scale, chord scale, broken chord scale, and chord progression in every key on every string instrument with minimal effort. All of the scales in music theory, therefore, are now infinitely reproducible at virtually no cost in an easy-to-follow more intuitive representation for any string instrument.

By utilizing a virtual instrument, the user may also record finger positions. The recorded information may then be either played back and analyzed by the user, or published to other users via the Internet or some other information transfer medium. The other users may then attempt to mimic the positions recorded by the original user, and thus be taught by the original user.

### BACKGROUND ART

The inventor is aware of several virtual musical instruments (both plucked string instruments and other types of instruments) available on devices such as the iPhone(Apple) and Android(Open Handset Alliance)—capable mobile devices. No existing virtual musical instrument provides the means to install and practice any song, nor do any existing virtual musical instruments provide any non instrument-specific musical instruction whatsoever.

The inventor is also aware of a software program called “ukulele hero” posted at www.hawaiiukulelehero.com that purports to allow the user to play an ukulele by pressing a number key when a traveling note hits a point on a string.

The inventor is also aware that the game called Dance Dance Revolution provides different colors for arrows with different rhythmic positions with respect to the downbeat.

The inventor is also aware of several game-console games which utilize a “guitar” consisting of a number of buttons and a three-position spring-loaded toggle to simulate the rhythm and general melodic form of any song. Such games can only teach users how to play songs on an instrument with exactly one string and several frets. Such games also often require the user to hold down multiple buttons while “plucking” just one “string” (simulated by the toggle). Clearly, such games do not aim to teach the user to play chords (multiple simultaneous musical notes (at most one note per string for string instruments)) on an actual guitar, as a maximum of one fret per string can be pressed to play any chord on any string instrument.

It is therefore an object of this invention to provide a computer program installed on a device which teaches the user to play any song on any string instrument.

It is also an object of this invention to avoid the costs and delays incurred by shopping for and purchasing a beginner's instrument, and all subsequent instruments, until such a purchase makes economical sense, as well as all printed sheet music, especially sheet music which pertains to music theory.

It is a further object of this invention to provide a device equipped with the means to create infinitely reproducible instructional content playable by the device, along with a means to distribute and receive such instructional content.

It is yet a further object of this invention to provide such a product on a device that is economical, compact and easily transported.

It is yet a further object of this invention to provide such a device by executing downloadable software from a file on a smart phone, tablet computer, or other device.

### DISCLOSURE OF INVENTION

These and other objects are obtained by a device, comprising a computer having a touch screen and software containing instructions that, when executed on the computer, makes the touch screen display a string representation of a string having a plurality of locations that can be touched to play a corresponding plurality of different musical notes. The software causes a note representation of a musical note to appear and travel along the string representation to a target area on the touch screen a fixed time interval before the note is to be played. The note representation reflects a correct location on the string representation on which it travels that must be touched to correctly play the note. The software informs a user when the note has been correctly played, by the user touching the string representation at the correct location when the note representation arrives at the target area, thereby causing the note representation to react.

In other words, the device is preferably a computer having a touch screen (including, without limitation, a smart phone or tablet computer) programmed with software containing instructions that cause the touch screen to display tablature for string instruments, preferably plucked string instruments, in an intuitive representation, in the following manner: a visual representation of each musical note to be played appears a fixed time interval before it is to be played. The display is divided into a number of sections—one section for every string on the instrument. A visual representation of each musical note to be played on a string appears in the corresponding section on the display and travels within that section (along the string) to a target area. The visual representation of the note reflects which location on the string representation must be depressed to correctly play the note. This can either be done with fret numbers (as with common guitar tablature) or with the actual name of the note (which would be used for fretless instruments), or in any other manner with a set of values that either maps in a one-to-one manner to the non-negative integers, as employed in tablature with numbers, or maps to the names of the different musical notes. If the user plays the correct note within a fixed tolerance of when it should be played (i.e., the traveling visual representation is within a certain distance of its target area when the note is played), the visual representation of the note will react in such a manner as to inform the user that the note has been played correctly, thus providing positive feedback for correctly playing the note.

In an additional possible mode of operation, the device has a microphone input into which the user plays a real string or other instrument (or sings), and the microphone input to the device is analyzed to determine the pitch. When the analysis yields a pitch which matches a note whose visual representation is within a specified tolerance of the target area, the representation of the note will react to notify the user that the note was played (or sung) correctly. Thus, if one attempts to play the song represented by the image on the screen into the microphone, each correctly played note will cause the corresponding representation on the screen to react, and each visual representation of a note which fails to react in the manner indicating that a note was correctly played corresponds to a note which was not correctly played (or sung) into the microphone. Thus the device can be used to learn how to play any song on any string or other instrument, or to sing any song. Such a configuration is possible on most modern computers equipped with a microphone.

In another possible mode of operation, the device displays the previously described information on top of a playable visual representation of the fretboard of the instrument (herein referred to as “virtual instrument”). A section of the screen is designated for “plucking” and the remainder is designated for “fingering”. Plucking includes all means for causing a string to vibrate, including (without limitation) plucking, strumming, picking, bowing or striking. When the user touches the area between the visual representation of the frets of the instrument in the “fingering” area and then drags a finger across a line representing a string displayed on the screen in the “plucking” portion of the screen, the speakers on the device play the note that would be emitted from a real instrument when the corresponding fret is held down and the corresponding string is plucked. As with the first described mode of operation, when a user causes the device to play a correct note, the corresponding visual representation of the note will react. Thus the device can be used to learn how to play any song on each string instrument's respective virtual version. Thus, one may use this device to learn how to play any song on any string instrument without ever picking one up. The device may also be configured to record the instantaneous position of each point of contact with the screen. Such content may be distributed via the internet or some other information transfer medium. Users who receive such content will be able to see the moment that each fret was first depressed, when each point of contact moved, and when each point of contact was released. Thus one may teach other users to play in an infinitely reproducible format.

Optionally, this device can be used to teach how to play a fretless string instrument, such as a violin.

### BRIEF DESCRIPTION OF DRAWINGS

FIG. 1 is a front view of a touch screen showing the invention in connection with a fretted string instrument having four strings, such as an ukulele or a conventional bass guitar.

FIG. 2 is a front view of a smart phone having a touch screen showing the invention in connection with a fretted string instrument having six strings, such as a guitar.

FIG. 3 is a front view of a smart phone having a touch screen showing the invention in connection with a fretless string instrument having four strings, such as a violin, viola, cello or string bass.

### BEST MODES FOR CARRYING OUT INVENTION

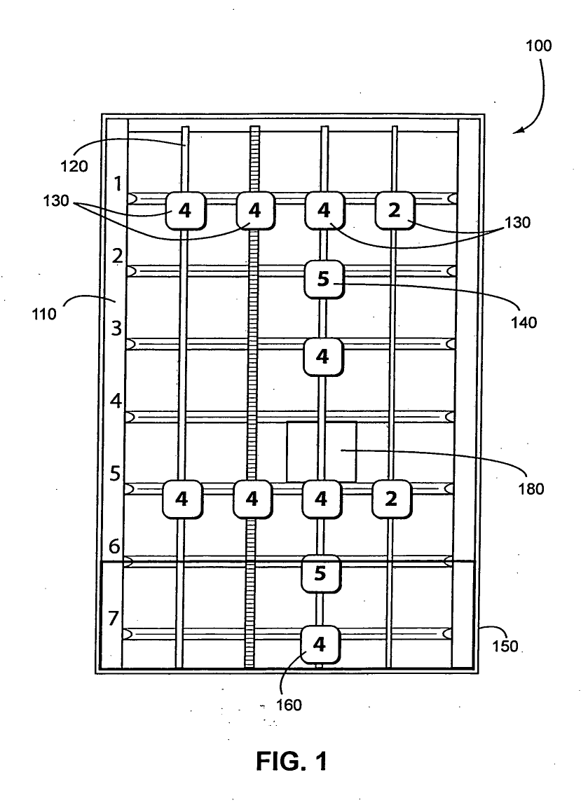

A first embodiment 100 of the best mode presently contemplated for carrying out the present invention is shown in FIG. 1, which shows string representations for an ukulele (or other fretted four string instrument) on a touch screen, with a vertical bar 110 identifying the frets by number. A string representation of the leftmost string 120 defines a vertical slice of the screen corresponding to notes to be played on the leftmost string. Representations of musical notes that are to be plucked preferably travel downwardly along the string representations. Here, multiple note representations 130 traveling at the same level indicate multiple strings are to be played simultaneously (such as to play a “chord”). The number of strings to be played simultaneously may vary, depending on the type of instrument, such as four for a ukulele and six for a conventional guitar. Preferably, the note representations display numbers to identify the frets to be depressed and played for the notes, with zero representing open strings (strings on which no frets are to be depressed when played).

Note that reference to a fret being depressed or played on a fretted instrument actually means that the user depresses the string against the fretboard between the specified fret and the next farthest fret from the body (depress the string “behind” the specified fret), so that the portion of the string extending from the fret and inward towards the body is free to vibrate. Accordingly, when a fret is described as being touched, depressed or played at a fret in this document, the user is actually to touch the area behind the specified fret, just as in a real fretted instrument. By contrast, in a fretless instrument, the user is to touch the actual area of the string necessary to play the desired note.

To better understand the manner in which the invention works, a single note representation 140 of a single musical note will be discussed. The single note representation 140 travels downwardly along the third string from the left and contains the number 5, thus indicating that the desired musical note is to be played by depressing the fifth fret on the third string from the left. The single note representation 140 (and all other note representations, including note representations 130) travels downwardly towards a target area 150 of the touch screen, preferably near the bottom. When any note representation, such as single note representation 140, reaches the target area, the note is to be played, preferably by touching the string representation (on which the single note representation 140 is traveling) at the fret reflected by the note representation to depress the fret, and then while the fret is depressed, touching the string representation (on which the single note representation 140 is traveling) in the target area 150. Optionally, the computer can be programmed so that touching the string representation in the target area with various motions can represent plucking, strumming or picking. In the illustrated embodiment 100, the target area is the “plucking” area in which the note is played by touching the touch screen, and the area above the target area is the “fingering” area, where the frets are depressed by touching the touch screen.

Preferably, if the musical note is correctly played by touching the string representation in the plucking area while touching the correct fret reflected in the note representation 140, when the note representation 140 reaches the target area 150, the note representation 140 reacts, such as by disappearing before it travels beyond the target area, similar to a video game. Preferably also, the computer has a loudspeaker and the musical note indicated by the note representation 140 is generated by the loudspeaker when the musical note is correctly played.

Because the single note representation 140 is closer to the target area 150 than the multiple note representations 130, the single note representation 140 reaches the target area 150 before the multiple note representations 130, so that the single note representation 140 is played before the multiple note representations 130.

Optionally, the note representation of a note which was not correctly played 160 travels beyond the target area instead of disappearing. In this first embodiment 100, each musical note that is correctly played disappears, so the note representation of a note which was not correctly played 160 appears below the target area, indicating that the musical note was not correctly played. As can be seen, the note representation which was not correctly played 160 should have been played by plucking the third string from the left while pressing the fourth fret 170 on the third string from the left: it is on the third string from the left and contains the number 4.

Optionally also, operation of the computer pauses when a note is not correctly played, and operation proceeds only when the note is correctly played, so that a user can play note by note, such as when learning a new piece.

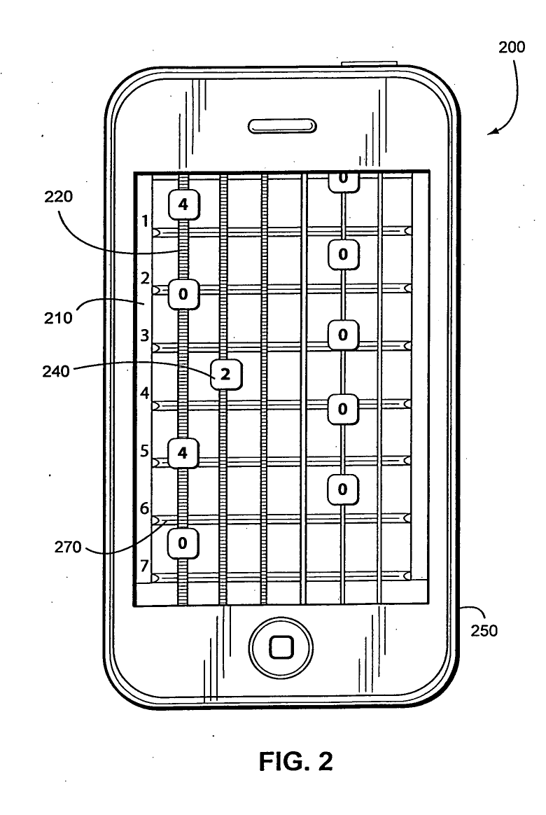

A second embodiment 200 of the best mode presently contemplated for carrying out the present invention is shown in FIG. 2, which shows string representations for a guitar (or other fretted six string instrument) on a smart phone having a touch screen, with a vertical bar 210 identifying the frets by number. A string representation of the leftmost string 220 defines a vertical slice of the screen corresponding to notes to be played on the leftmost string. Representations of musical notes that are to be played (plucked, strummed, or picked) preferably travel downwardly along the string representations. Here, none of the note representations travels at the same level, so none of the musical notes is to be played simultaneously. Also, the third and fourth string representations from the left are not to be played, because there are no note representations traveling along them. Note also that the fifth string from the left is to be played without fretting, as indicated by the “0” in the note representations traveling along it.

Similar to the first embodiment, a single note representation 240 of a single musical note travels downwardly along the second string from the left and contains the number 2, thus indicating that the desired musical note is to be played by pressing the second fret on second string from the left. Again, the single note representation 240 (and all other note representations) travels downwardly towards a target area 250 on the touch screen, preferably near the bottom. When any note representation, such as single note representation 240, reaches the target area, the note is to be played, preferably by touching the string representation (on which the single note representation 140 is traveling) in the target area 250. Again, optionally, the computer can be programmed so that touching the string representation can represent plucking, strumming or picking. In the illustrated embodiment 200, the target area 250 is the “plucking” area in which the note is played, and the area above the target area is the “fingering” area, where the frets are depressed by touching the touch screen on the frets reflected by the note representations.

Again, if a musical note is correctly played by touching the string representation in the plucking area while depressing the correct fret indicated in the note representation 140, when the note representation 140 reaches the target area 150, the note representation 140 reacts, such as by disappearing before it travels beyond the target area.

Preferably also, the computer has a loudspeaker and the musical note indicated by the note representation 140 is generated by the loudspeaker when the musical note is correctly played.

Again, optionally, the note representation of a note which was not correctly played 160 travels beyond the target area, or operation of the computer stops until the note has been played correctly, or both.

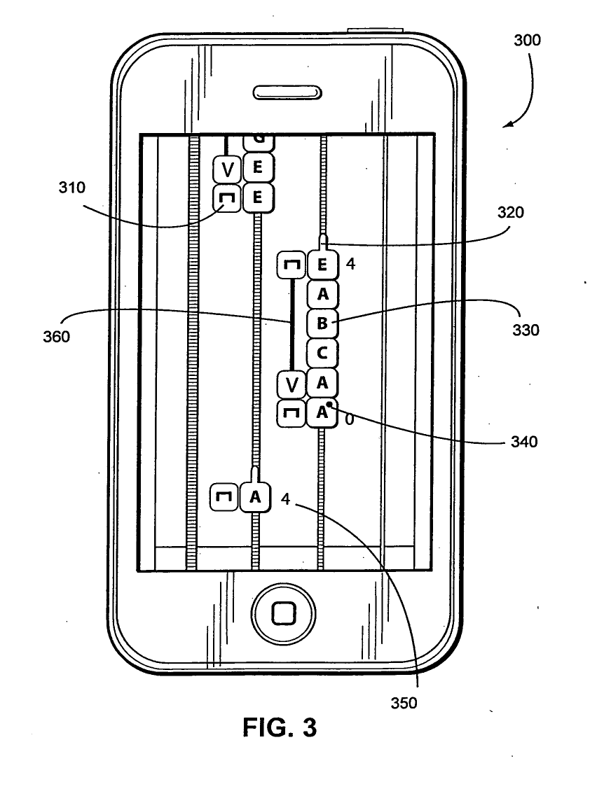

A third embodiment 300 of the best mode presently contemplated for carrying out the present invention is shown in FIG. 3, which shows string representations for a violin (or other fretless four string instrument) on a smart phone having a touch screen. In this embodiment, additional information is provided adjacent to, or in, the note representations, such as:

a bowing marking 310 (indicating that the note representation immediately to the right should be played with a down bow);

a duration marking 320 (the length of this visual element denotes how long the note from which it extends should be held);

the name of a musical note 330 (showing a B played on the A string (third from left));

an articulation marking 340 (the dot in the upper right hand corner of the note representation indicates mezzo staccato articulation—without this marking, preferably musical notes played immediately before or after using the same stroke of the bow should be moderately detached);

a fingering marking 350 (the “4” immediately to the right of the

note representation indicates that the note should be played with the fourth (pinky) finger on the left hand); and

a bow duration marking 360 (the length of this visual element

denotes how long the bow stroke from which it extends should be played, which is only necessary if more than one note is to be played on the same bow stroke, commonly called a slur).

Optionally, the note representations can be provided with colors to denote rhythmic position with respect to the downbeat of the music. For example, in 4/4 time, green notes could be on the downbeat (to correspond to quarter notes), blue notes could be halfway between green notes (to correspond to eighth notes), and red notes could be halfway between blue notes (to correspond to sixteenth notes). Alternatively, each of the twelve notes in the chromatic scale could be shown with a different color. Alternatively, position within the measure may be denoted by a geometric shape of the note representation, with colors reserved for pitch-color correspondence, which may be customized to the user's preferences. This may both facilitate self-discovery of preferences and expedite the learning process.

In all the above embodiments, preferably, the note representations appear at the top of the screen and travel to the bottom of the touch screen. In order to facilitate correct timing of each note, a metronome may be drawn, preferably in the form of a brightly colored rectangle which is periodically drawn over the area within which a note whose visual representation will appear during the period of time in which the note may be played.

For music intended to be played with a pick (or plectrum), instead of touching the touch screen with a finger, a plectrum tipped with a material with the capacitance of a human finger can be used.

For music which is intended to be played in a “finger style” as opposed to being played with a plectrum (or pick), it is preferable to include one or more plucking instructions with each visual representation of each note. This may be done with letters corresponding to the conventional notation of the letter ‘p’ for a pluck with the thumb, ‘i’ the index finger, ‘m’ the middle finger, and ‘a’ the ring finger, or with numbers, or with four distinct symbols.

For music which involves strumming patterns, arrows may be used in the manner employed in conventional notation for guitars. An arrow pointing in the direction of the strum may be drawn near the visual representations of the notes constituting the chord.

In addition, if a visual representation of the instrument is present (regardless of which proposed mode of operation is being utilized), it may be beneficial to visually alter the areas of the fretboard which must be depressed in order to correctly play a future different note. For example, referring to FIG. 1, the area which the user must touch in order to cause the fifth fret of the third string from the left to be depressed in the future, as indicated by the single note representation 140, can be highlighted by, for example, overlaying a semi-transparent rectangle 180. This also allows separating the timing of the actions of the fingering hand from the actions of the plucking hand—the user can continue to pluck in tempo (at the rate required for playing the music) while having time to prepare to change to a future different fret, so that the change to the different future fret can also be accomplished in tempo. Additionally, one or more fingerings may be described within the rectangle 180. In this manner, the future area to be touched to play the correct future fret for a future note can optionally be highlighted before the user must change frets, thus allowing the user time to prepare to play the future fret and thereby play the future note in tempo.

A mode of operation which implements this invention as a virtual instrument is preferably achieved in the following manner: by dragging a finger along the vertical bar 110 of FIG. 1, a user is able to “shift”, or adjust which frets are visible and thus playable. Preferably, placing a finger on any part of the “fingering” section of the display will cause exactly one fret on exactly one string to become depressed. Optionally, each finger placed on the “fingering” section can be dragged horizontally to “bar”, or depress a single fret over multiple strings. Optionally also, each finger placed on the “fingering” section can also be dragged vertically along the length of a string representation to change which fret is being depressed. These two actions commute. More advanced fingering techniques such as “hammer-ons” and “pull-offs” may be achieved by the inclusion of an additional button which, if pressed, will allow the player to either press a finger down in the fingering section to cause the corresponding note to immediately sound (assuming no other higher fret on the same string is depressed) in addition to pressing the fret—known as a “hammer-on”—or remove a finger which is currently touching the fingering section to cause the note corresponding to the highest depressed fret on the same string as the finger to sound, in addition to releasing the fret (again assuming no higher fret on the same string is depressed)—known as a “pull-off” (when no frets on the same string are depressed, the open string is played).

Alternatively, each fret on each string may be divided into two regions—one on either side of the string. Hammer-ons are played by placing a finger to the left of the string (placing a finger to the right of the string will not register as a hammer-on). Pull-offs are achieved by dragging a finger from the left region into the right, and then releasing the finger. Additionally, a device equipped with an accelerometer may implement a jerk (derivative of acceleration with respect to time) threshold below which hammer-ons do not register.

It is beneficial to utilize the internet or some other information transfer medium to facilitate the transfer of sheet music that has been translated into the intuitive representations provided by devices using software according to the present invention. It is also beneficial to provide a mode of operation whereby a user may record the positions of touches on the touch screen and to create content in the same format as that which is ordinarily read by the device.

### INDUSTRIAL APPLICABILITY

This invention is applicable whenever musical instruction on a string instrument is required. Thus, this invention is particularly valuable when the value of musical instruction is outweighed by the costs involved in musical instruction and—in the case of the mode of operation utilizing the virtual instrument—the costs of purchasing and maintaining a real musical instrument. This invention is also applicable whenever recording of instructional content pertaining to music played on a plucked string instrument is required. This facilitates instantaneous capture of instructional content in an infinitely reproducible format.

What is claimed is:

1. A string instrument educational device, comprising:
a computer having a touch screen; and
software containing instructions that, when executed on the computer, makes the touch screen:
display a string representation of a string having a plurality of locations that can be touched to play a corresponding plurality of different musical notes;
cause a note representation of a musical note to appear and travel along the string representation to a target area on the touch screen a fixed time interval before the note is to be played, wherein the note representation reflects a correct location on the string representation on which it travels that must be touched to correctly play the note; and
inform a user when the note has been correctly played by the user touching the string representation at the correct location when the note representation arrives at the target area, by causing the note representation to react.

2. A string instrument educational device, according to claim 1,
further comprising a speaker operatively connected to the computer;
wherein the software further causes the computer to audibly generate the note through the speaker when the note is correctly played.

3. A string instrument educational device, according to claim 1,
wherein the reaction of the note representation is to disappear.

4. A string instrument educational device according to claim 1, wherein the software also causes the touch screen to display frets under the string representation, and the frets define the plurality of locations on the string representation that can be touched to play a corresponding plurality of different musical notes; and
wherein the note representation reflects the fret to be touched to correctly play the note.

5. A string instrument educational device, according to claim 1,
wherein for the note to be correctly played, the software further requires that a finger touch the string representation in a plucking area when the note representation arrives at the target area, while the user touches the string representation at the correct location.

6. A string instrument educational device, according to claim 1,
wherein for the note to be correctly played, the software further requires that a finger be dragged across the string representation in a plucking area when the note representation arrives at the target area, while the user first touches the string representation at the correct location.

7. A string instrument educational device according to claim 1,
wherein information about the note to be played selected from the group consisting of plucking instructions, strumming patterns, bowing instructions, articulation markings, name of note, fingering markings, and subdivision within measures, appears in or adjacent to the note representation.

8. A string instrument educational device, according to claim 1,
wherein the software further causes the computer to pause when a note is not correctly played, and to resume after the note is played correctly.

9. A device according to claim 1, wherein said software also records the instantaneous position of each point of contact with said touch screen.

10. A device according to claim 1, wherein said software further visually alters a future area to play a correct location on the string representation to play a future note.

11. A string instrument educational device, comprising:
a computer having a screen and a microphone input to which a real string instrument can be connected for analysis of pitch played by the real string instrument;
software containing instructions that, when executed on the computer, makes the screen:
display a string representation of a string having a plurality of locations that can be depressed to play a corresponding plurality of different musical notes;
cause a note representation of a musical note to appear and travel along the string representation to a target area on the screen a fixed time interval before the note is to be played, wherein the note representation reflects a correct location on the string of the real instrument that must be played to correctly play the note;
analyze pitch from the real string instrument connected to the microphone input; and
inform a user when the note has been correctly played by the user playing a pitch on the real instrument when said analysis yields a pitch which matches the note representation within a specified tolerance of the target position, by causing the note representation to react.

12. A string instrument educational device, comprising:
a computer having a touch screen; and
software containing instructions that, when executed on the computer, makes the touch screen:
display a string representation of a string having a plurality of locations that can be touched to play a corresponding plurality of different musical notes, and an adjacent plucking area that can be touched for plucking said string representation, wherein a portion of said string representation overlays a fingering area;
cause a note representation of a musical note to appear and travel along said string representation to a target area a fixed time interval before said note is to be played, wherein the note representation reflects a correct location on the string representation on which it travels that must be touched to correctly play the note;
inform a user when the musical note has been correctly played by the user touching the touch screen at the string representation in the plucking area, while touching the touch screen at the correct portion of the string representation in the fingering area, when the note representation arrives at the target area.

13. A downloadable computer-readable file containing instructions that, when executed, makes a computer having a touch screen and a speaker become a virtual instrument, comprising:
software that:
displays a string representation of a string having a plurality of locations that can be touched to play a corresponding plurality of different musical notes;
causes a note representation of a musical note to appear and travel along the string representation to a target area on the touch screen a fixed time interval before the note is to be played, wherein the note representation reflects a correct location on the string representation that must be touched to correctly play the note; and
informs a user when the note has been correctly played by the user touching the string representation at the correct location when the note representation arrives at the target area, by causing the note representation to react and by playing the musical note through the speaker.

14. A computer-readable storage medium containing instructions that, when executed, cause a computer having a touch screen and a speaker to become a virtual instrument, comprising:
software that:
displays a string representation of a string having a plurality of finger positions on the string representation on which the user can place fingers to play a corresponding plurality of different musical notes, to cause sounds to be emitted from said speaker;
generates sounds through said speaker responsive to said finger positions; and
records said finger positions for future playback.

15. A process for using a computer having a touch screen, comprising:
executing software on said computer containing instructions that, when executed, make the touch screen:
display a plurality of string representations, each of which has a plurality of locations that can be touched to play a corresponding plurality of different musical notes;
cause at least one note representation of a musical note to appear and travel along at least one of said string representations to a target area on the touch screen a fixed time interval before the musical note is to be played, wherein each note representation reflects a correct location on the string representation on which it travels that must be touched to correctly play that note; and
inform a user when a note has been correctly played by the user touching the string representation at the correct location when the note representation arrives at the target area, by causing the note representation to react.

16. A computer-readable storage medium containing instructions that, when executed, makes a computer having a touch screen and a speaker become a virtual'instrument, comprising:
software that:
displays a string representation of a plurality of strings on a string instrument, each of which has a plurality of locations that can be touched to play a corresponding plurality of different musical notes, and a plucking area for plucking each of said string representations, wherein a portion of each of said string representations overlays a fingering area;
causes a note representation of at least one musical note to appear and travel along at least one of said string representations to a target area a fixed time interval before the musical note is to be played, wherein the note representation reflects a correct location on the string representation on which it travels that must be touched to correctly play that note;
informs a user when the note has been correctly played by the user touching the string representation on the touch screen in the plucking area, while touching the touch screen at the correct location of the string representation in the fingering area, when the note representation arrives at the target area.

17. A computer-readable storage medium according to claim 16, wherein:
said touching of the string on the touch screen in the plucking area is dragging a finger across said string representation.

18. An article of manufacture, comprising:
a computer-readable storage medium;
software stored on said storage medium containing instructions that, when executed, makes a computer having a touch screen and a speaker become a virtual instrument by:
displaying a string representation of a plurality of strings on a string instrument, each of which has a plurality of locations that can be touched to play a corresponding plurality of different musical notes, and a plucking area for plucking each of said string representations, wherein a portion of each of said string representations overlays a plucking area;
causing a note representation of at least one musical note to appear and travel along at least one of said string representations to a target area a fixed time interval before the musical note is to be played, wherein the note representation reflects a correct location on the string representation on which it travels that must be touched to correctly play that note; and
informing a user when the note has been correctly played by the user touching the touch screen at a portion of the string representation in the plucking area, while touching the touch screen at the correct location of the string representation in the fingering area, when the note representation arrives at the target area.
